(19) United States
(12) Patent Application Publication
(10) Pub. No.: US 2012/0090241 A1
(43) Pub. Date: Apr. 19, 2012

(54) Child proof entry system

(76) Inventor: Jean Alexander, Maplewood, NJ (US)

(21) Appl. No.: 13/065,019

(22) Filed: Mar. 11, 2011

Related U.S. Application Data
(60) Provisional application No. 61/340,095, filed on Mar. 11, 2010.

(51) Int. Cl. E06B 9/04

(52) U.S. Cl. 49/55

(57) ABSTRACT

The present invention a specially designed child safety device that effectively blocks entrance into rooms such as kitchens, bathrooms, and garages that normally contain dangerous items. Constructed of a durable heavy duty plastic and, in another embodiment, aluminum, this versatile product is configured to fit virtually any doorway, with dimensions of approximately twenty seven inches in height and twenty eight and one half inches in width. The unit features an accordion like extension for wider doorways. The base of the unit is basically rectangular in shape, and used to brace the latch to the inside of the drawer or cabinet. Unique to the Child Proof Entry System is a high tensile, coiled spring located in the interior of the base, which allows for turning the unit to a locked position. Extending from the base is an elongated tubular stem containing the latch mechanism that secures the door in place. Attached to the stem and serving as the control handle of the Child Proof Entry System, a circular flange operates the spring and latch features of the unit.

### CLAIM OF PRIORITY

This patent application claims priority under 35 USC 119 (e) (1) from U.S. Provisional Patent Application Ser. No. 61/340,095 filed Mar. 11, 2010, of common inventorship herewith entitled, “CHILD PROOF ENTRY SYSTEM.”

### FIELD OF THE INVENTION

The present invention pertains to the field of child safety devices, and more specifically to the field of child access safety devices.

### BACKGROUND OF THE INVENTION

The prior art has put forth several designs for child access safety devices. Among these are:

U.S. Pat. No. 5,272,840 to Roy E. Knoedler, et al describes a gate which is provided for use as a closure device within a doorway and includes an L-shaped frame member which may be positioned in stationary relationship to the doorway and a panel member which is pivotally mounted to the frame member. The panel member carries a latching mechanism including a latch for engaging a lower horizontal extension of the frame member to prevent pivotal movement of the panel portion. In addition, a contact member is provided for contacting a surface of the doorway when the latch member is engaged with the frame. A release lever is provided for moving the contact member out of engagement to allow pivotal movement of the panel relative to the frame. A locking member is provided for preventing operation of the lever such that the locking member must be operated simultaneously with the lever in order to release the contact member.

U.S. Pat. No. 5,782,039 to Craig S. Scherer, et al describes a two-section portable gate which carries a rotatable control handle at an upper surface thereof for purposes of installation and removal of the gate in a doorway. When the handle is rotated to an extended state, the two sections of the gate can be moved relative to one another to fill the opening in the doorway. When the handle is moved to an intermediate position, the gate sections are locked together and further relative movement is not possible. When the handle is moved to a closed or locked position adjacent to an upper surface of the gate, the gate sections are forced apart a predetermined distance thereby creating normal forces, and in turn frictional forces, which lock the gate into position in the doorway and resist its removal. Spring loaded bumpers can be used on edges of the gate sections to take into account non-square openings.

U.S. Pat. No. 6,119,754 to Teresa M. Okonsky describes a retractable gate assembly that can be mounted either on or recessed within a wall. The assembly preferably comprises an alarm system to notify others that the gate is being touched. The gate assembly is most commonly used as a baby-gate at the top and bottom of stairwells, or at kitchen entrances to avoid injury. The gate assembly is also used as a pet-gate.

None of these prior art references describe the present invention.

### SUMMARY OF THE INVENTION

It is an object of the present invention to provide a child proof access safety device.

### BRIEF DESCRIPTION OF THE DRAWINGS

FIG. 1 is an elevational angled perspective view of the device of the present invention in its closed configuration.

FIG. 2 is an elevational angled perspective view of the device of the present invention in its open configuration.

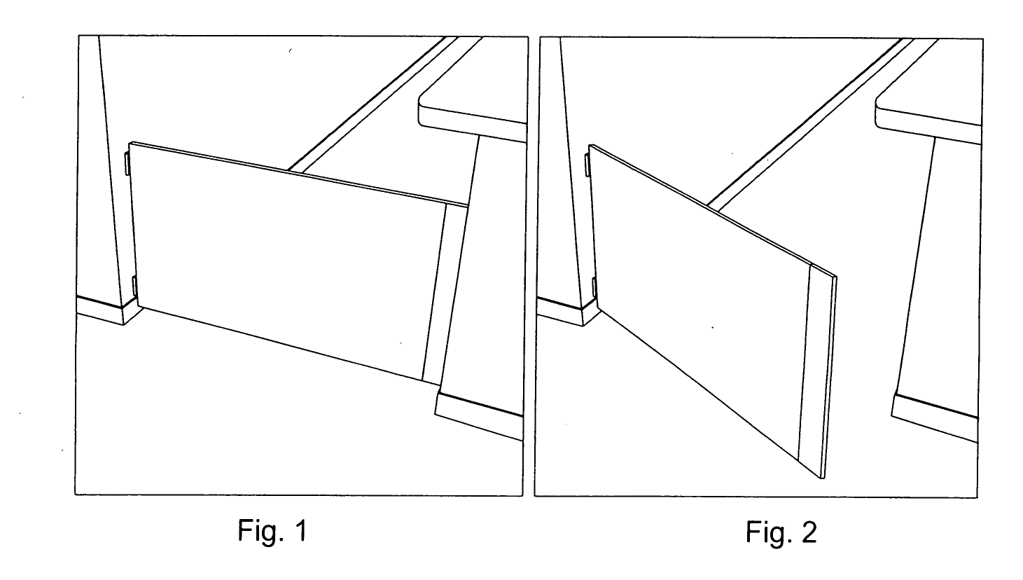

### DETAILED DESCRIPTION OF THE INVENTION

While most parents make every effort to protect their children from potential risks in the home environment that lead to an episode of accidental poisoning, it is daunting to keep up with a small child's unrestrained curiosity. Young children, especially toddlers, are extremely inquisitive by nature. Developing mentally as well as physically at a rapid pace during these years, these children want to learn everything possible about the world around them. Poking through closets and opening drawers and cabinets are very common ways curious children seek appealing and interesting objects. To protect children from the toxic exposure of drugs, chemicals, and other household hazards commonly found in these areas, parents typically use childproofing safety latches on cabinets and drawers. However, the majority of these devices available on the market are not as effective as they should be. Constructed of lightweight and flimsy plastic, these latches typically do not lock a cabinet door or drawer. Thus, when a child attempts entry, there is still an opening large enough for a small hand to sneak through. In addition, a smart and persistent toddler easily breaches one of these latches, and gains unimpeded access to potentially harmful substances.

The present invention, hereinafter referred as the Child Proof Entry System is a specially designed child safety device that effectively blocks entrance into rooms such as kitchens, bathrooms, and garages that normally contain dangerous items. Constructed of a durable heavy duty plastic and, in another embodiment, aluminum, this versatile product is configured to fit virtually any doorway, with dimensions of approximately twenty seven inches in height and twenty eight and one half inches in width. The unit features an accordion like extension for wider doorways. The base of the unit is basically rectangular in shape, and used to brace the latch to the inside of the drawer or cabinet. Unique to the Child Proof Entry System is a high tensile, coiled spring located in the interior of the base, which allows for turning the unit to a locked position. Extending from the base is an elongated tubular stem containing the latch mechanism that secures the door in place. Attached to the stem and serving as the control handle of the Child Proof Entry System, a circular flange operates the spring and latch features of the unit. As additional consideration, this product is offered in a variety of colors and packaged with multiple units for use in several areas of the home.

Use of the Child Proof Entry System is very simple and straightforward. First, the user purchases the appropriate size unit for whatever area they desire to secure. By way of example, a father needs a larger Child Proof Entry System to keep his son out of cabinets in the utility room. Similarly, a mother opts for a smaller unit to deter her small daughter from getting into the bathroom.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A child proof access safety device, comprising a child safety device that effectively blocks entrance into rooms such as kitchens, bathrooms, and garages that normally contain dangerous items, comprising durable heavy duty plastic, configured to fit any doorway, wherein the device comprises an accordion like extension for wider doorways, and wherein the base of the device is essentially rectangular in shape, and used to brace the latch to the inside of the drawer or cabinet, and wherein the device includes a high tensile, coiled spring located in the interior of the base, which allows for turning the unit to a locked position, and wherein extending from the base is an elongated tubular stem containing the latch mechanism that secures the door in place, and wherein attached to the stem and serving as the control handle is a circular flange which operates the spring and latch.

2. The device of claim 1 wherein the device is constructed of aluminum.

3. The device of claim 1 wherein the dimensions are approximately twenty seven inches in height and twenty eight and one half inches in width.

4. The device of claim 1, wherein the surface of the device is covered in a variety of colors.

5. The device of claim 1 wherein the device is packaged with multiple units for use in several areas of the home.
